(19) United States
(12) Patent Application Publication
(10) Pub. No.: US 2008/0036922 A1
(43) Pub. Date: Feb. 14, 2008

(54) Slim depth projection television console

(75) Inventor: Richard E. Huber, Lebanon, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, LLC., Wayne, NJ (US)

(21) Appl. No.: 11/783,429

(22) Filed: Apr. 9, 2007

Related U.S. Application Data
(60) Provisional application No. 60/789,924, filed on Apr. 7, 2006.

(51) Int. Cl. H04N 5/74

(52) U.S. Cl. 348/784

(57) ABSTRACT

A front projection television system includes a screen and a console arranged in front of and below the screen. The console includes an optical projector for projecting light onto the screen.

### CROSS-REFERENCE TO RELATED APPLICATION

This application claims the benefit under 35 U.S.C. Section 119(e) of provisional application No. 60/789,924, filed Apr. 7, 2006, the contents of which are incorporated herein by reference in their entirety.

### BACKGROUND AND SUMMARY

It is desirable to introduce television models with large screens and slim depth, with the ultimate target of being hung upon a wall. Current flat panel technologies such as PDP and LCD are slim enough to hang on a wall (4-6″), but are heavy and expensive. CRT based rear projection systems are about 24″ deep and generally require bulky floor standing cabinets. Newer generation micro-display rear projection systems are slimmer (˜15″). Next generation micro display rear projection systems are now being developed which utilize aspherical optics and/or signal manipulation to shrink cabinet depth to around 8″.

There exist front projection systems that can display a picture directly onto a screen or wall but require difficult installation (on ceiling, etc) and require long projection distance, making them unsuitable to install in many rooms.

Additional challenges arise with wall-hung and front projection televisions involving cosmetically appealing wire management and storage/placement of audio/visual components and supplemental audio system.

The example systems and arrangements described herein provide an ultra-slim depth television system providing a wall mountable display screen together with a cosmetically appealing cabinet/console capable of containing all wiring and components.

### BRIEF DESCRIPTION OF THE DRAWINGS

FIG. 1 is a diagram of a rear-projection television system.

FIG. 2 is a diagram of another rear-projection television system.

FIGS. 3 and 4 schematically show a front projection television system.

FIG. 5 is a more detailed diagram of an example embodiment of a front projection television system.

### DETAILED DESCRIPTION OF EXAMPLE EMBODIMENTS

The example systems and arrangements described herein can use the optical systems being developed for slim depth rear projection micro-display televisions. These systems can be arranged to that the light engine is placed below the screen. Of course, other optical systems may be used in the front projection television systems and arrangements described herein.

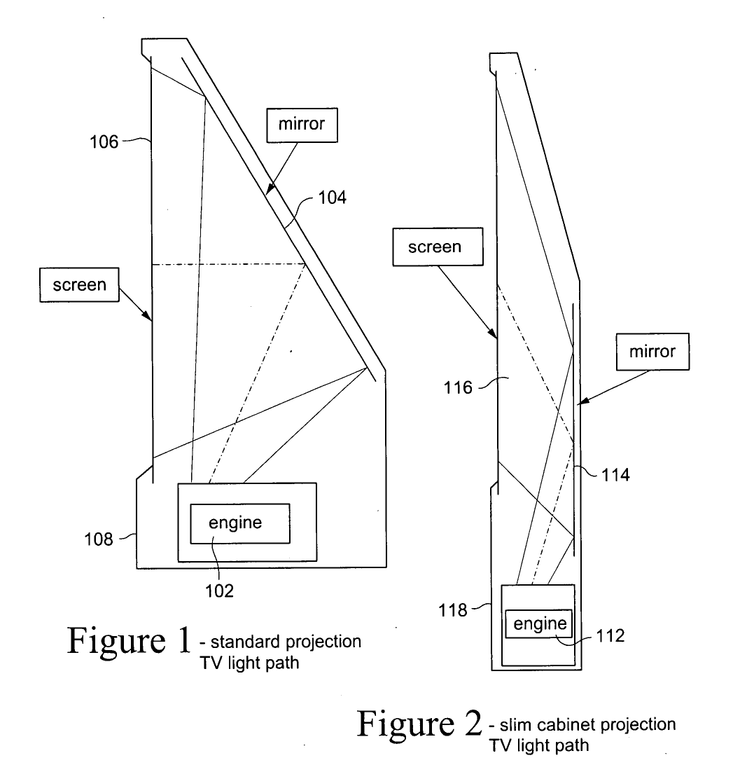

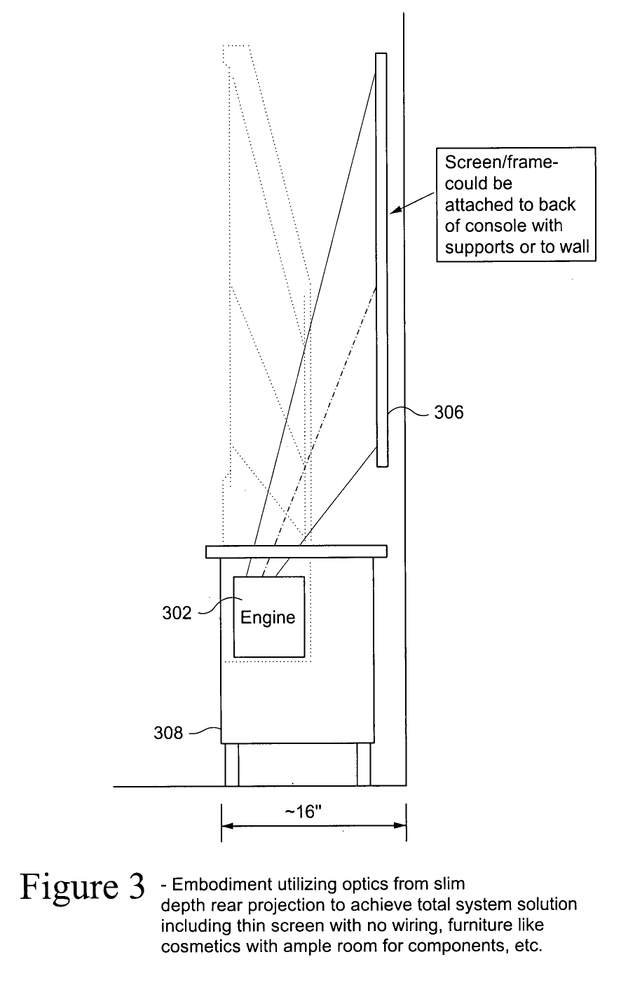

Standard rear projection systems utilize a large mirror to reflect the image so that the light is directed in a generally perpendicular orientation to the back of the screens as shown in FIG. 1. As shown in FIG. 1, the light output from a light engine 102 housed in a cabinet 108 is reflected by a mirror 104 onto a rear side of screen 106. Aspherical optics allow an image to be projected onto a screen at a steep angle, by correcting for the variations in focal length and severe trapezoidal distortion. As shown in FIG. 2, such optics allow a light engine 112 to be housed in a relatively slim cabinet 118. Light output from light engine 112 in FIG. 2 is reflected by mirror 114 onto a rear side of screen 116.

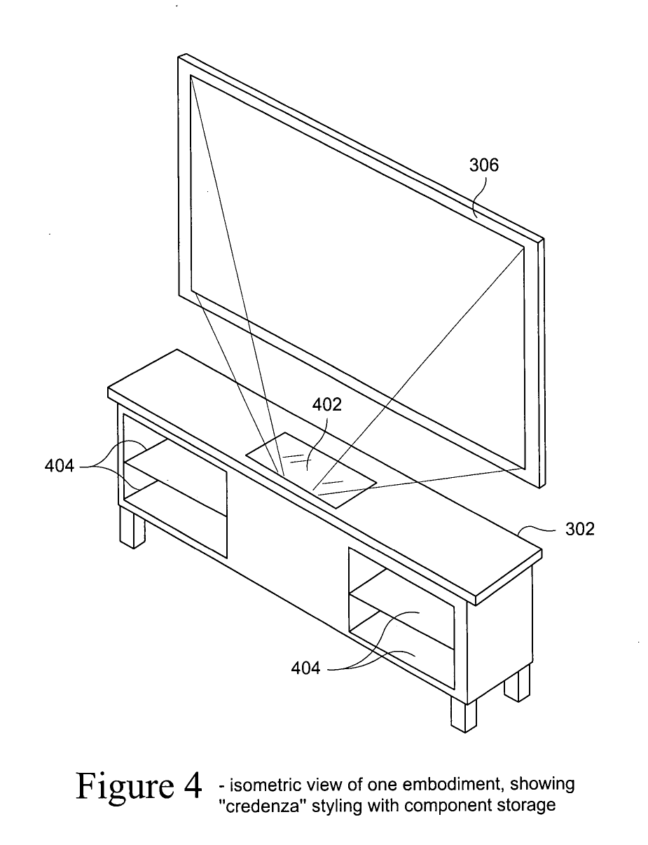

The example system described herein uses an optical system similar to the system shown in FIG. 2 to provide a slim-depth (e.g., approximately 16 inch deep) front projection console 302 coupled with a less than 1 inch deep display screen as schematically shown in FIGS. 3 and 4. Console 302 houses a light engine 302 and conventional electronics (not shown) as well as providing storage and location for separate components. For example, shelves 404 can, by way of example without limitation, hold set-top boxes for cable and/or satellite systems, VCRs, PVRs (or DVRs), DVD players/recorders, video game machines, speakers, and the like. Connections for transferring audio, video and/or data between these components and the television may be provided using standard connections including, but not limited to, HDMI, DVI, component video, S-video, audio, USB and/or RF connections. Multi channel audio systems can also be integrated into console 302.

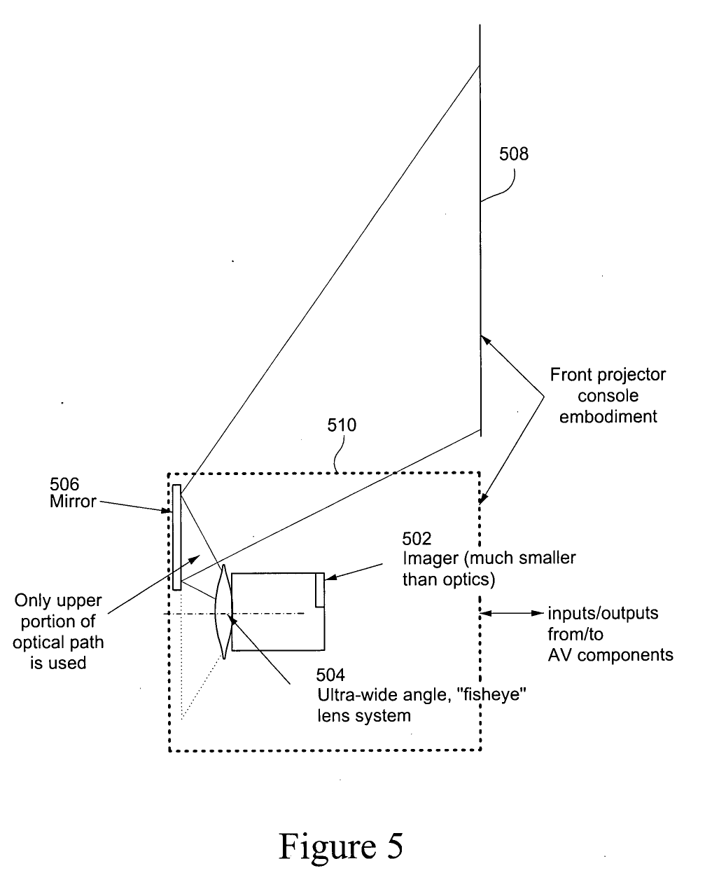

FIG. 5 shows a specific example implementation that can be used to provide a slim-depth system. As shown in FIG. 5, the output of an imager 502 passes through an ultra-wide angle fish-eye lens system 504. The output of the imager may correspond to a tuned television channel, a DVD output, etc. An upper portion of the fish-eye lens system output is reflected by mirror 506 onto a front side of screen 508. Imager 502, fish-eye lens system 504 and mirror 506 are contained in a console 510. The upper surface of console 510 includes a light-transmitting opening (e.g., an anti-reflective glass window) through which the reflected output passes. This is shown by way of example without limitation as a window 402 in FIG. 4.

An example of a light engine style that can be used in the FIG. 5 arrangement is an InFocus light engine that has been incorporated in rear projection televisions such as the RCA model HD61THW263. InFocus is a trademark of InFocus Corporation. Light engines using asymmetrical optics designed to correct for the “off-axis” nature of the light path shown in FIG. 5 may also be used. By way of still further example, light engines using image geometry correction may also be used. By way of illustration, the Silicon Optix Image AnyPlace system includes image geometry correction.

The top of the console may be a decorative surface with a small anti-reflective glass window in the center. The light path will be such that this top surface will be largely usable for decorative items, additional components, and the like without generating shadows on the screen.

The screen may be fixed directly to supports attached to the back of the console, or hung directly onto the wall (with proper adjustment). In certain example implementations, the light output from mirror 506 may be projected directly onto a wall of a room in which the television is located.

Flatter screens can improve display quality. Some options for the screen include using tempered glass with a screen surface applied as a laminated film or silk screen, using fabric screens mounted under tension to a rigid frame, and the like.

While the systems and arrangement have been described above in connection with what is presently considered to be the most practical and preferred embodiment, it is to be understood that various modifications and equivalent arrangements are intended to be included within the spirit and scope of the appended claims.

1. A front projection television system comprising:
a screen; and
a console arranged in front of and below the screen, the console including an optical projector arranged to project light onto a front side of the screen.

2. The front projection television system according to claim 1, wherein the screen is fixedly attached to the console.

3. The front projection television system according to claim 1, wherein the console comprises an upper surface having a window therein through which the light from the optical projector is projected onto the screen.

4. The front projection television system according to claim 1, wherein the depth of the console is 16 inches or less.

5. The front projection television system according to claim 1, wherein the console comprises one or more compartments configured to hold television components.

6. A front projection television system comprising:
a light engine for outputting light; and
a mirror for reflecting at least a portion of the light output from the light engine onto a front side of a display area positioned above and behind the light engine.

7. The front projection television system according to claim 6, further comprising:
a lens system arranged in the light path between the light engine and the mirror.

8. The front projection television system according to claim 7, wherein the lens system focuses only a portion of the light output from the light engine onto the mirror.

9. The front projection television system according to claim 6, wherein the display area comprises a screen.

10. The front projection television system according to claim 6, wherein the display area is a wall.
